(19) United States
(12) Patent Application Publication
(10) Pub. No.: US 2007/0062911 A1
(43) Pub. Date: Mar. 22, 2007

(54) Method and device for supplying at least one machining station for a workpiece

(76) Inventor: Sönke Siebels, Hamburg (DE)

Correspondence Address: FRIEDRICH KUEFFNER, 317 MADISON AVENUE, SUITE 910, NEW YORK, NY, 10017, US

(21) Appl. No.: 10/575,709

(22) PCT Filed: Oct. 12, 2004
(86) PCT No.: PCT/DE04/02258

§ 371 Date: Apr. 12, 2006

(30) Foreign Application Priority Data
Oct. 31, 2003 (DE) 103 51 330.2

(51) Int. Cl. H01H 33/66

(52) U.S. Cl. 218/136

(57) ABSTRACT

The invention relates to a method and a device for supplying at least one vacuum machining station. A first part of a supply device is arranged on a rotatable carrier element and is guided in such a way that it can be displaced in relation to a fixed second part of the supply device. A gap extends at least partially between the first part and the second part of the supply device, said gap being at least partially unsealed from the environment.

The invention concerns a method for supplying vacuum to at least one workpiece processing station, in which at least a first part of a supply device moves on a rotating carrier and is movably guided relative to a stationary part of the supply device.

The invention also concerns a device for supplying vacuum to at least one workpiece processing station, which device has a supply device, at least a first part of which is mounted on a rotatable carrier, and in which the first part of the supply device is movably guided relative to a stationary, second part of the supply device.

Methods and devices for supplying processing stations with a vacuum are known in a variety of forms. For example, in the blow molding of containers, suction pockets arranged on a rotating transfer wheel are used, which are connected to a vacuum source by a rotary distributor and convey blown containers discharged from a blowing station to a delivery line.

Comparable methods and devices are also used to support the processing of workpieces that are inserted in a processing station with a vacuum chamber. Processing methods of this type can be realized, for example, for plasma sterilization or for plasma coating. Corresponding processing of containers can involve the treatment of internal surfaces and/or external surfaces of the containers.

For example, in connection with the plasma coating of bottle-shaped workpieces, PCT-WO 01/03186 discloses the assignment of different vacuum sources in groups to a plurality of processing stations and control of the vacuum supply with the use of a disk-like distributing device, in which an upper disk part rotates relative to a stationary, lower disk part.

In connection with an air-lock device, EP 0 943 699 A discloses a drum-like vacuum distribution system, in which an inner part of the drum is stationary, and an outer part of the drum rotates relative to the inner part.

A general requirement in prior-art devices is assurance of the greatest possible tightness of the supply device from the outside environment for the purpose of preventing the penetration of outside air and a resulting reduction of the vacuum. Sealing measures of this type consist, for example, in the use of spring-supported seals, along which the moving part slides or which are guided, together with the moving part, along the stationary part. In another variant, a layer of grease is provided between the stationary part and the moving part to prevent the penetration of outside air.

The previously known methods and devices lead to wear due to the sliding of the materials on each other, so that only relatively short service lives are possible. A special problem has been found to be that increasing wear leads to the development of leaks that are variable with respect to time and can be compensated only by very complicated means.

The objective of the present invention is to specify a method of the aforementioned type which results in reduced wear and increased process stability.

In accordance with the invention, this objective is achieved by guiding the first part of the supply device relative to the second part, which is separated from the first part by a gap, which is positioned in such a way that, at least in certain regions, there is no seal from the outside environment.

A further objective of the present invention is to design a device of the aforementioned type in such a way that its service life is extended.

In accordance with the invention, this objective is achieved by virtue of the fact that a gap, which, at least in certain regions, is unsealed from the outside environment, extends at least partially between the first part and the second part of the supply device.

The use of an at least partially unsealed gap between the first part and the second part of the supply device is an approach to the problem which is contrary to the prior-art approach. The previously realized methods and designs have not sufficiently taken into consideration the fact that in the production of a vacuum, a maximum pressure difference of 1 bar exists relative to the outside environment. Furthermore, it was not taken into consideration that, regardless of the given pressure difference that is realized, the propagation velocity of the air flow that develops cannot exceed the speed of sound. As a result, for a well-defined and essentially constant gap area, a maximum volume flow can be determined, which can be compensated by an increased pumping capacity.

For a technically realizable minimum gap width on the order of a few tenths of a millimeter, the pumping capacity must be increased by about 10% to 20%, typically about 15%, which also results in a corresponding increase in operating costs. These increased operating costs are offset by the avoidance of frequent replacement of worn parts and the avoidance of downtime caused by these replacement operations. Taking just the offsetting effects of the savings of materials and the avoidance of production downtime into consideration, an overall cost reduction is achieved. Furthermore, the leakage that occurs is essentially constant with respect to time, so that relatively uncomplicated compensation is possible. Accordingly, in addition to the economic savings, significantly improved process quality can be achieved.

The gap width is typically dimensioned at about 0.1 mm to 0.3 mm.

To produce an effective pressure reduction, it is proposed that at least two vacuum pumps be arranged one after the other in the direction of motion of the carrier.

In particular, it has been found to be advantageous to use at least two vacuum pumps with different vacuum levels.

A high production rate can be realized if at least two processing stations are arranged one after the other in the direction of motion of the carrier.

The charging and discharging of the workpieces in the vicinity of the processing station is assisted by arranging at least one of the vacuum pumps on the rotating carrier.

In accordance with another design variant, it is proposed that at least one of the processing stations be arranged on the rotating carrier.

A coupling-like design of the supply device and/or the accomplishment of a controlled distribution of vacuum is assisted if the supply device, at least in certain regions, has two disks, between which the gap extends.

In accordance with another embodiment, it is also possible for the supply device to comprise at least one cylindrical inner part and one outer part that surrounds the inner part, between which the gap extends.

When a plurality of processing stations is used, it has been found to be effective if the supply device is designed, at least in certain regions, as a vacuum distributor.

Other control possibilities for presetting the negative pressures that develop are provided if the processing station includes at least one control valve for the predeterminable separation of two interior regions of the processing station.

In one specific embodiment, the processing station includes suction pockets for carrying out a transfer of the workpieces.

In addition, it is also proposed that the processing station be designed for the plasma treatment of workpieces.

To support predetermined process conditions in the vicinity of the processing station, it is proposed that at least in certain regions along the gap, a pressure gradient be produced by at least two vacuum pumps.

In the case of an internal arrangement of the rotating carrier, it is provided that the carrier is designed as a carrier wheel.

In the case of an external arrangement of the rotating carrier, it is advantageous for the carrier to be designed as a carrier ring.

Specific embodiments of the invention are illustrated schematically in the drawings.

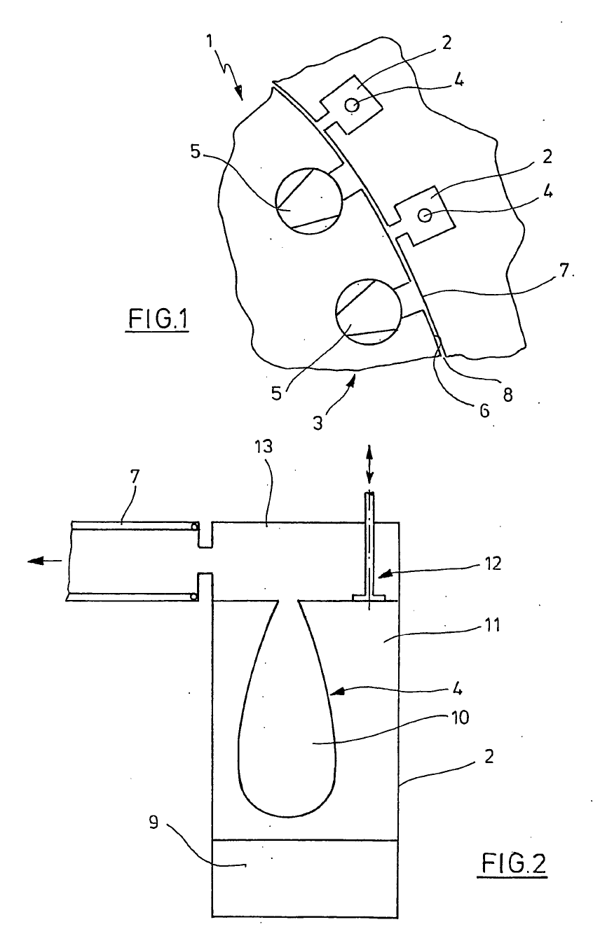

FIG. 1 shows a partial schematic top view of a carrier wheel with vacuum pumps and with processing stations mounted in stationary positions along the periphery of the carrier wheel.

FIG. 2 shows a schematic view of a processing station for treating bottle-shaped workpieces.

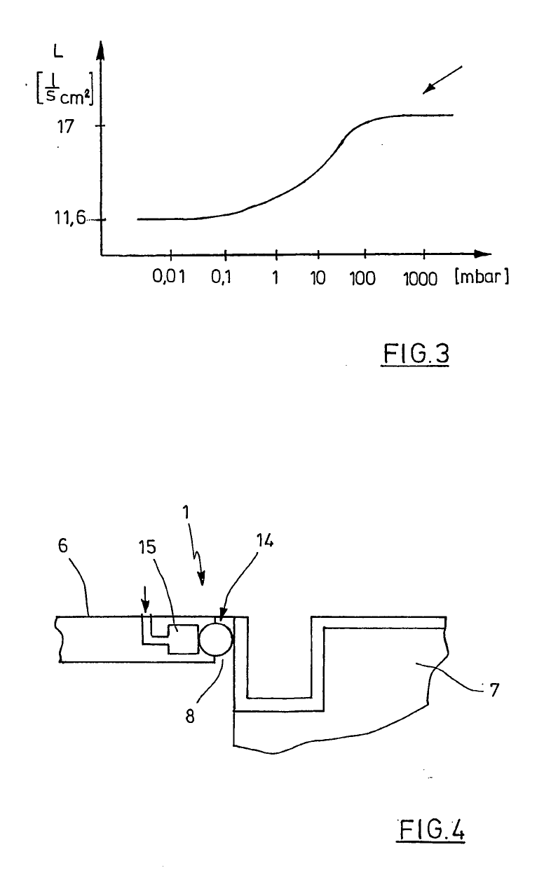

FIG. 3 shows a volume flow-time graph to illustrate blocked flow.

FIG. 4 shows a schematic view to illustrate the use of additional sealing elements.

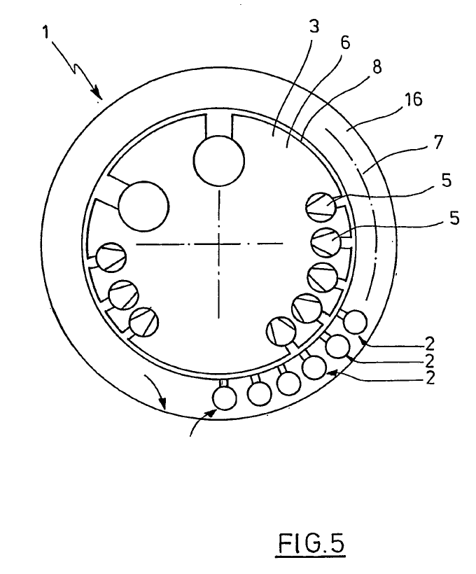

FIG. 5 shows a complete schematic view of the carrier wheel with vacuum pumps that is only partially shown in FIG. 1.

According to the view in FIG. 1, a supply device 1 for supplying processing stations 2 with vacuum is provided with a carrier 3, which is rotatably supported and realized as a carrier wheel. Workpieces 4 can be arranged in the vicinity of the processing station 2, and vacuum pumps 5 are mounted on the carrier 3.

To connect the processing station 2 to the vacuum pumps 5, a first part 6 of the supply device 1 is arranged in the vicinity of the carrier 3, and a second part 7 of the supply device 1 extends in the vicinity of the processing station 2 for this purpose. A gap 8, which extends without a seal, at least in certain regions, is located between the first part 6 and the second part 7 of the supply device.

The illustrated outlet connections cover essentially the entire height or width of the gap 8 to ensure a well-defined separation of the pressure zones.

FIG. 2 schematically illustrates the structure of a processing station for workpieces 4. In one embodiment of the processing station 2 for plasma treatment of workpieces 4, the processing station 2 is typically furnished with a microwave 9. According to the embodiment in FIG. 2, the workpiece 4 is formed as a hollow body. A chamber space 11 of the processing station 2 partially surrounds the workpiece 4. An interior space 10 of the workpiece 4 and the chamber space 11 can be supplied with different negative pressures.

The different negative pressures are produced in such a way that a lower pressure is produced in the interior 10 of the workpiece 4 than in the chamber space 11. The equipment necessary to accomplish this will now be explained. During the evacuation process, after the predetermined negative pressure in the chamber space 11 is reached, a control valve 12 closes. The control valve 12 connects the chamber space 11 with an antechamber 13, into which the second part 7 of the supply device 1 and the interior 10 of the workpiece 4 open. As the evacuation process continues after the control valve 12 has closed, the pressure level is further reduced only in the area of the antechamber 13 and the interior 10 of the workpiece 4, while the negative pressure in the area of the chamber space 11 remains essentially unchanged.

FIG. 3 shows a graph of the volume flow as a function of the pressure with respect to a gap-shaped flow channel. The graph shows that the volume flow initially increases with increasing pressure difference at the gap 8. However, depending on the geometry of the gap, after a certain saturation, a so called blocked flow develops as a result of the fact that the propagation velocity of flowing air cannot exceed the speed of sound. Even an increasing pressure difference in the vicinity of this blocked flow does not lead to a significant increase in the volume flow.

FIG. 4 shows an embodiment in which a sealing element 14 is additionally used in one region of the gap 8. The sealing element 14 can be tensioned by a pneumatic servomechanism 15, so that the sealing forces acting here can be preset. Furthermore, it is also possible to preset sealing forces that are variable with respect to time by means of the pneumatic servomechanism 15 in order to preset a high level of sealing and the wear that results from it only when specific process conditions actually require it. For example, two peripheral sealing rings can be used as the sealing element 14.

The realization of a gap design in which the gap 8 is open to the outside environment in certain regions and sealed in certain regions leads to an optimization of its characteristics and contributes to the realization of an optimum compromise between the development of wear and an optimum seal.

FIG. 5 shows a complete view of the carrier wheel with vacuum pumps that is only partially shown in FIG. 1. Alternatively to the use of a rotating carrier wheel, it is also possible to mount the vacuum pumps 5 illustrated in FIG. 5 on a stationary middle section and to position the processing stations 2 on a rotatable carrier ring. It is also possible to arrange the vacuum pumps 5 externally and the processing stations 2 internally, as opposed to the way in which they are arranged in FIG. 5. In this case as well, depending on the design boundary conditions, it is possible to predetermine whether the internal or the external components are arranged on a rotatable carrier 3.

In accordance with FIG. 5, several vacuum pumps 5 arranged one after the other in the direction of conveyance in the area of the discharge of the workpieces 4 from the processing stations 2 produce individual pressure levels to prevent an overflow of gas into the process space.

1. Method for supplying vacuum to at least one workpiece processing station, in which at least a first part of a supply device moves on a rotating carrier and is movably guided relative to a stationary part of the supply device, wherein the first part (6) of the supply device (1) is guided relative to the second part (7), which is separated from the first part (6) by a gap, which is positioned in such a way that, at least in certain regions, there is no seal from the outside environment.

2. Method in accordance with claim 1, wherein the vacuum is produced by at least two vacuum pumps (5) with different pressure levels.

3. Method in accordance with claim 1, wherein at least two vacuum pumps (5) are positioned one after the other in the direction of motion of the rotating carrier (3).

4. Method in accordance with claim 1, wherein at least two processing stations (2) are arranged one after the other in the direction of motion of the rotating carrier (3).

5. Method in accordance with claim 1, wherein the processing station (2) is moved together with the carrier (3).

6. Method in accordance with claim 1, wherein the vacuum pump (5) is moved together with the carrier (3).

7. Method in accordance with claim 1, wherein the supply vice (1) distributes the vacuum to a plurality of processing ations (2).

8. Method in accordance with claim 1, wherein the processing station (2) carries out a plasma treatment of the workpieces (4).

9. Device for supplying vacuum to at least one workpiece processing station, which device has a supply device, at least a first part of which is mounted on a rotatable carrier, and in which the first part of the supply device is movably guided relative to a stationary, second part of the supply device, wherein a gap (8), which, at least in certain regions, is unsealed from the outside environment, extends at least partially between the first part (6) and the second part (7) of the supply device (1).

10. Device in accordance with claim 9, wherein the gap (8) has a gap width of about 0.1 mm to 0.3 mm.

11. Device in accordance with claim 9, wherein at least two vacuum pumps (5) are arranged one after the other in the direction of motion of the carrier (3).

12. Device in accordance with claim 9, wherein at least two vacuum pumps (5) with different vacuum levels are used.

13. Device in accordance with claim 9, wherein at least two processing stations (2) are arranged one after the other in the direction of motion of the carrier (3).

14. Device in accordance with claim 9, wherein at least one of the vacuum pumps (5) is arranged on the rotating carrier (3).

15. Device in accordance with claim 9, wherein at least one of the processing stations (2) is arranged on the rotating carrier (3).

16. Device in accordance with claim 11, wherein the supply device (1), at least in certain regions, has two disks, between which the gap (8) extends.

17. Device in accordance with claim 9, wherein the supply device (1) comprises at least one cylindrical inner part and one outer part that surrounds the inner part, between which the gap (8) extends.

18. Device in accordance with claim 9, wherein the supply device (1) is designed, at least in certain regions, as a vacuum distributor.

19. Device in accordance with claim 9, wherein the processing station (2) includes at least one control valve (12) for the predeterminable separation of two interior regions of the processing station (2).

20. Device in accordance with claim 9, wherein the processing station (2) includes suction pockets for carrying out a transfer of the workpieces (4).

21. Device in accordance with claim 9, wherein the processing station (2) is designed for the plasma treatment of workpieces (4).

22. Device in accordance with claim 9, wherein at least in certain regions along the gap (8), a pressure gradient is produced by at least two vacuum pumps (5).

23. Device in accordance with claim 9, wherein the carrier (3) is designed as a carrier wheel.

24. Device in accordance with claim 9, wherein the carrier (3) is designed as a carrier ring.
